(19) United States
(12) Patent Application Publication
(10) Pub. No.: US 2011/0307240 A1
(43) Pub. Date: Dec. 15, 2011

(54) DATA MODELING OF MULTILINGUAL TAXONOMICAL HIERARCHIES

(75) Inventors: Daniel Kogan, Issaquah, WA (US); Patrick Miller, Sammamish, WA (US); Paula Wing, Sammamish, WA (US); Qinwei Zhu, Kirkland, WA (US)

(73) Assignee: MICROSOFT CORPORATION, Redmond, WA (US)

(21) Appl. No.: 12/813,252

(22) Filed: Jun. 10, 2010

(51) Int. Cl. G06F 17/28

(52) U.S. Cl. 704/2

(57) ABSTRACT

Translations are provided as a property in multilingual taxonomical hierarchies. Translations for each node in a tree structure are associated with the node of a primary language as labels, where each node can have a plurality of labels. If the translation into a secondary language does not exist, a default label and language combination may be designated to be used in place of the missing secondary language during rendering.

### BACKGROUND

With the proliferation of networking and network based processing, web based services and web applications are taking over the traditional computing tasks performed by locally installed applications. Locally installed applications, as their name suggests, need to be installed, maintained, and updated at the local level making it difficult to manage larger systems such as enterprise computing systems, where hundreds or thousands of users need attention and support of the information technology personnel. Web applications, on the other hand, are accessed by users through thick or thin clients with much easier maintenance since there is one main application to be installed, maintained, and updated. An illustrative example of web based applications is document sharing services, which provide document creation, editing, and sharing services through a simple user interface such as a browsing application user interface. Because the application is centrally managed, many features that were difficult of impractical in locally installed applications may be provided. One such feature is multilingual document support.

Data presented in some web based applications may be structured in a hierarchical organization. The classification of terms (data) according to a predefined relationship is also referred to as taxonomy. In multilingual applications, a specific relationship between different nodes that model translation may need to be created. This greatly increases the complexity of the system, both in modeling, where the taxonomist needs to keep track of both the conceptual hierarchy as well as every translation relationship, and in viewing, where a user cannot simply switch their viewing language.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing translations of a term as property in multilingual taxonomical hierarchies. Translations for each node in a tree structure may be associated with the node of primary language as labels, where each node may have a plurality of labels. A default label and language combination may be designated to be used in place of a missing secondary language during rendering if a translation into the secondary language does not exist.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating various multilingual taxonomical trees including one according to embodiments;

FIG. 2 is another conceptual diagram illustrating use of labels to associate translations with nodes in a taxonomical tree;

FIG. 3 illustrates creation and rendering of multilingual hierarchy structures in a system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of data modeling of multilingual taxonomical hierarchies according to embodiments.

### DETAILED DESCRIPTION

As briefly described above, each node in a taxonomical tree may be assigned one or more labels based on supported languages rather than having a new tree or node in a tree for each language. One of the labels may be designated as the default label representing one of the supported languages in the system that is selected as the default. If a node has not been translated into a certain language, the default label for the default system language may be used. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing networked computer systems, which may provide multilingual taxonomical hierarchy support. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

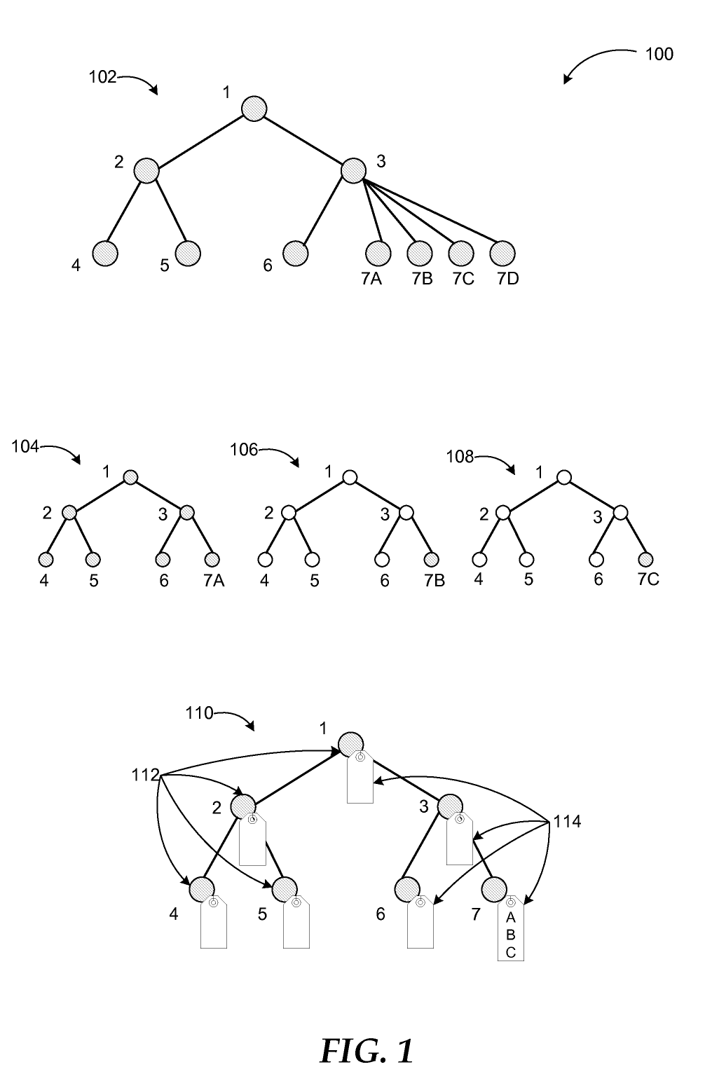

FIG. 1 is a conceptual diagram illustrating various multilingual taxonomical trees including one according to embodiments. Taxonomy is the practice of classification according to natural relationships and is one approach used to organize content in a web site. Taxonomy may be created from vocabularies that contain related terms. For example, taxonomy vocabulary classifying music by genre with terms and sub-terms may look like:
Vocabulary=Music
   term=classical
      sub-term=concertos
      sub-term=sonatas
      sub-term=symphonies
   term=jazz
      sub-term=swing
      sub-term=fusion
   term=rock
      sub-term=soft rock
      sub-term=hard rock

Thus, any content hierarchy in web based applications may be organized through taxonomical tree structures. In web based applications supporting multiple languages, translations of terms within the content need to be organized in a similar fashion to the original language terms. One such approach is shown in hierarchy 102 of diagram 100. Root node 1 branches out to child nodes 2 and 3. Child node 2 branches out to child nodes 4 and 5. Each of these nodes may represent a term. Child node 3 branches out to child nodes 6 and 7A through 7D, where 7A through 7D represent different language versions of the same term. Thus, a new node may be added to the hierarchy preserving a relationship within the tree structure.

Another approach is re-creating the same tree structure for each translation version as shown by hierarchies 104, 106, and 108. As shown in the diagram, some of the nodes in hierarchies 106 and 108 are white, while others and all nodes in hierarchy 104 are grey. Hierarchy 104 may represent a default (or primary) language structure. All terms are included in the tree structure. Some of the terms may not have translations in other languages. Thus, some nodes in secondary language trees 106 and 108 may be omitted nodes in the other language trees.

Both approaches described above require creation of specific relationships between different nodes that model the translation(s) increasing the complexity of the system in modeling and rendering. For example, in the multiple hierarchy approach introduces the additional complexity of maintaining relationships between each tree structure corresponding to a language.

Hierarchy 110 of diagram 100 illustrates a tree structure according to embodiments. Nodes 112 representing terms are assigned labels 114 (as a property). Translations of a particular term may then be associated with the primary language term through the labels. Each node may have a plurality of labels.

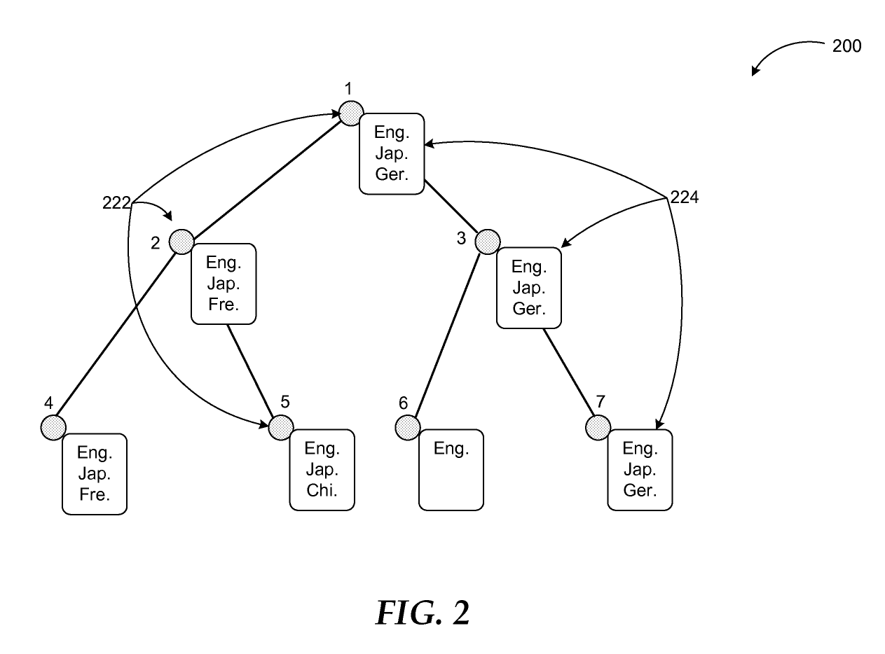

FIG. 2 is another conceptual diagram illustrating use of labels to associate translations with nodes in a taxonomical tree. In a system according to embodiments, translations are modeled as core properties rather than being modeled as separate relationships of a given node. This means that any particular taxonomy term (or conceptual item) includes all available translations. Thus, any action taken on the original term may apply to all translations at the same time. If the term is deleted, all corresponding translations are deleted. If a term is marked as no longer being valid (e.g. within the system including the web application), all translations are handled in the same way.

A list of translatable languages may be tracked as well as the default language for the system. Then, for every term in the system, a full set of labels may be associated with the term. A label may be a name that the term can be known as, for example, “United States”, “USA”, “United States of America”, “États-Unis”. For every language with a label, one label may be denoted as the default for that language. The default label is the label that appears whenever the term is shown, for example, in a document, in a web page, or in a tree view for a user to select from.

If a particular node does not have a translation, then the system default language may be used. When the default language of the system is changed, terms that have not yet been translated may be assigned the default term in the previous default language. Furthermore, multiple terms in a particular language may map to a single term in the default language. For example, a particular concept in English may be described by two or more terms in Japanese. In such cases, the different translations may also be associated with the same node as different properties.

Thus, labeling based modeling of translations in multilingual taxonomical hierarchies may be used for one-to-one translations, one-to-many translations, multiple descriptions, and even synonyms. In diagram 200, nodes 222 are shown with corresponding labels 224. Nodes 222 are associated with default language English. A majority of the nodes have Japanese as a secondary language, while node 6 has only English. Some nodes have French and others German as tertiary language. During rendering, if German is selected as working language, English versions of the terms for nodes without German translations may be used (e.g. displayed or played if audio is being used).

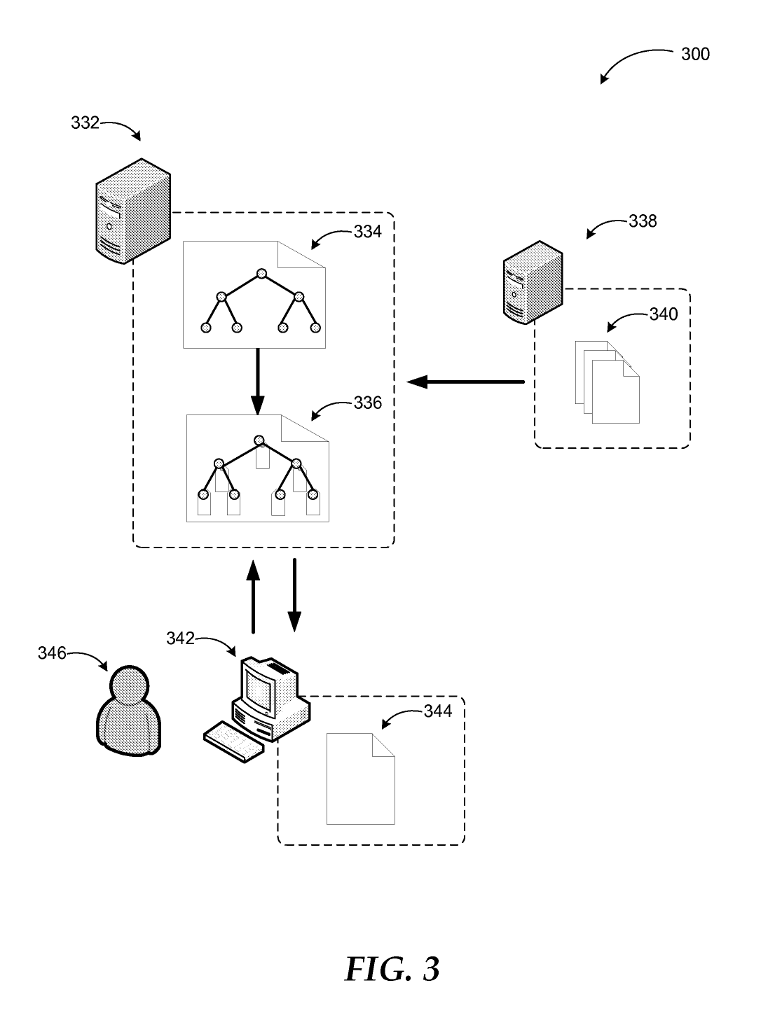

FIG. 3 illustrates creation and rendering of multilingual hierarchy structures in a system according to embodiments. Server 332 represents a service that organizes data in taxonomical hierarchies 334 for consumption by users (e.g. user 346) through their client devices/applications 342.

Once a taxonomical hierarchy 334 is created, translations of terms corresponding to nodes of the hierarchy may be provided by a separate application executed by server 332 or by an external translation provider 338. Translations 340 may include one-to-one translations or one-to-many translations in other languages or dialects. Embodiments are not limited to languages or dialects, however. Specialized cultural vocabularies such as legal culture, military culture, medical culture, and similar ones may also be used to provide equivalent text strings, descriptions, synonyms, etc. Furthermore, audio files may also be used in addition to textual data to form original tree structures and annotate them with labels.

The translations may be added to the original taxonomical hierarchy 334 as properties of individual nodes and a default language selected such that if a translation of a particular node does not exist in a user selected working language, the default version is used. Thus, the annotated hierarchy 336 may be used to render documents or provide selection options 344 to user 346 through client application/device 342.

The example systems in FIG. 1 through 3 have been described with specific components such as hierarchic schemas, translations, and configurations. Embodiments are not limited to multilingual taxonomical hierarchy modeling according to these example configurations. Furthermore, specific orders of operations are described for providing hierarchies with multiple language support. Embodiments are also not limited to the example orders of operations discussed above.

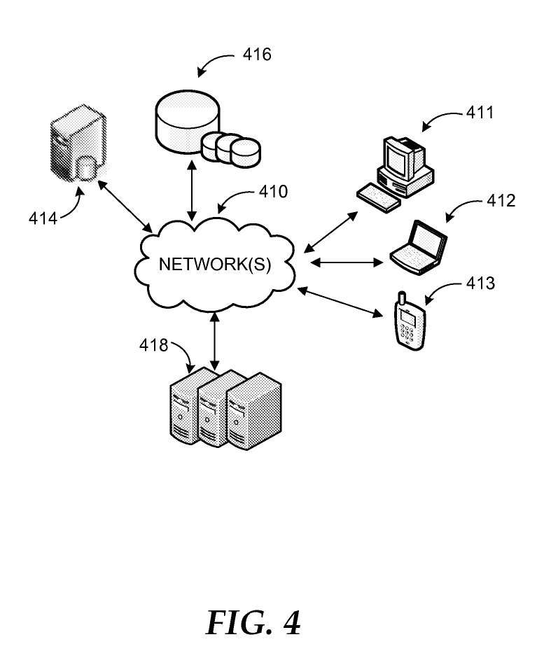

FIG. 4 is an example networked environment, where embodiments may be implemented. A web based application providing multilingual hierarchy modeling capability may be implemented via software executed over one or more servers 418 such as a hosted service. The system may facilitate communications between client applications on individual computing devices such as a smart phone 413, a laptop computer 412, and desktop computer 411 (‘client devices’) through network(s) 410.

As discussed previously, translations of original terms structured as nodes in a taxonomical hierarchy may be added to the structure as properties associated with each node rather than having a new tree or node in a tree for each language. One of the supported languages in the system may be selected as the default. If a node has not been translated into a certain language, the default label for the default system language maybe used instead.

Client devices 411-413 may be thin clients managed by a hosted service. One or more of the servers 418 may provide a portion of operating system functionality including hierarchy annotation through labels. Data such as the translations and original terms may be stored in one or more data stores (e.g. data store 416), which may be managed by any one of the servers 418 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement multilingual runtime rendering of metadata. Furthermore, the networked environments discussed in FIG. 4 are for illustration purposes only. Embodiments are not limited to the example applications, modules, or processes.

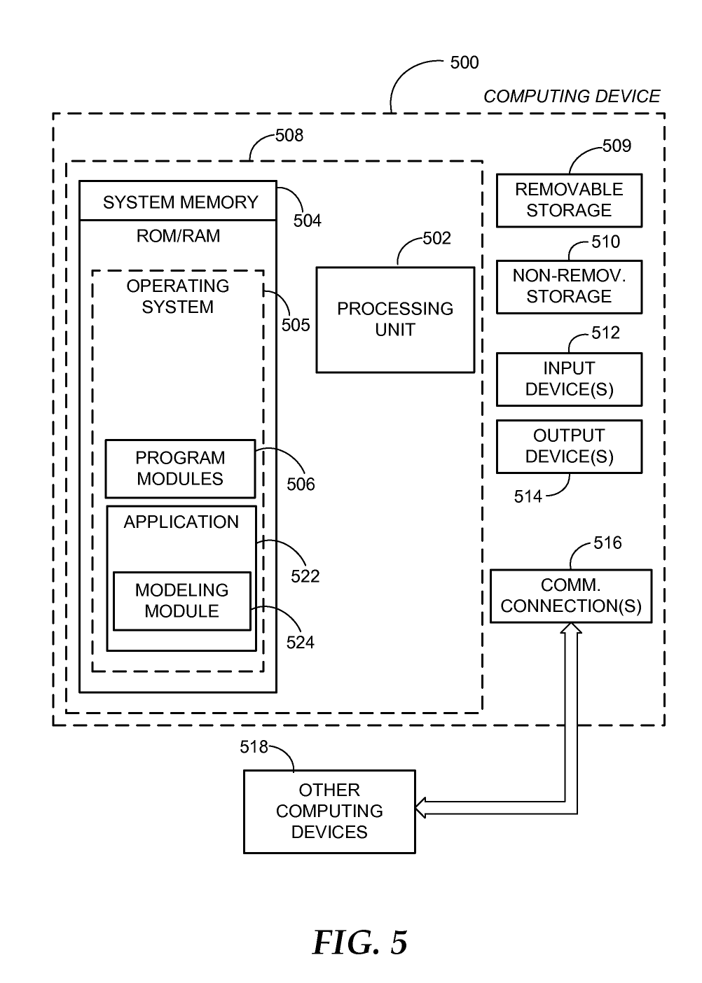

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server providing a web based application and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, application 522, and modeling module 524.

Application 522 may be any web based application using hierarchically structured data for rendering services to users. Multilingual support for the services may be provided through annotating a taxonomical hierarchy structure with labels corresponding to various translations for each node in the structure. Modeling module 524 may annotate the tree structure with the translations by adding corresponding translations as properties of each node and designating a default language for use in case of absence of a working language translation for a node. Application 522 and modeling module 524 may be separate applications or integrated components of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include servers, desktop computers, handheld computers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

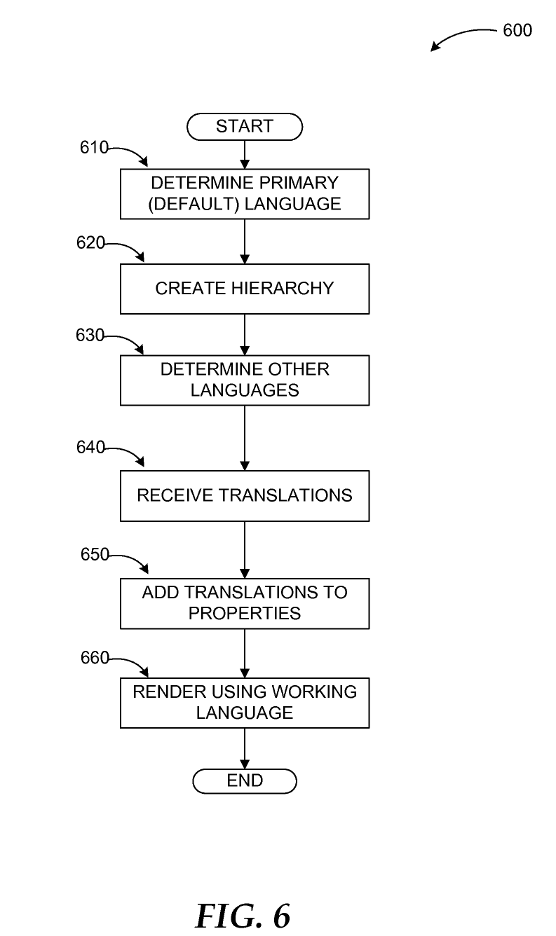

FIG. 6 illustrates a logic flow diagram for process 600 of data modeling of multilingual taxonomical hierarchies according to embodiments. Process 600 may be implemented as part of a web based system.

Process 600 begins with operation 610, where a primary or default language is determined for terms (data) to be organized in a taxonomic hierarchy. The term language as used herein may refer to dialects or specific cultural vocabulary, and is not limited to national or spoken languages. At operation 620, the taxonomical hierarchy may be created with each node in the tree structure corresponding to a term, which may be a word or a group of words in textual or audio format. At operation 630, languages, in which translations of the terms are available or will be available, may be determined. For example, in establishing a document sharing service, the administrators may define specific secondary languages for predefined regions.

The translations may be received by the system (or performed) at operation 640. Not all terms may have translations in particular languages available. At operation 650, the translations may be added to the taxonomical hierarchy as labels to each corresponding node such that multilingual rendering of the data structure may be supported at operation 660 upon detection of a working language desired by a user. For terms without a translation in a particular language, the default language label may be used.

The operations included in process 600 are for illustration purposes. Data modeling of multilingual taxonomical hierarchies according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for modeling multilingual taxonomical hierarchies, the method comprising:
determining a default language for data organized in a taxonomical hierarchy;
determining at least one other language to be used in providing translations of at least a portion of the data;
receiving the translations; and
integrating the translations into the taxonomical hierarchy as core properties of corresponding nodes.

2. The method of claim 1, wherein each translation of a node in the hierarchy is associated with the node as a label such that an action taken on the node is applied to all labels associated with the node.

3. The method of claim 2, wherein the action includes at least one from a set of:
rendering a term specified by the node through a client application, deleting the term, and marking the term as invalid.

4. The method of claim 3, wherein the term includes at least one from a set of: a character string, a word, a group of words in one of: text and audio format.

5. The method of claim 1, further comprising:
determining a working language desired by a user through a client application;
providing translations of data in the working language for rendering by the client application.

6. The method of claim 5, further comprising:
if a translation in the working language for a particular node of the hierarchy is unavailable, providing a default language version of the node.

7. The method of claim 1, further comprising:
changing the default language to one of the translation languages.

8. The method of claim 7, further comprising:
if a translation for a particular node of the hierarchy is unavailable in the new default language, using the previous default language version of the node.

9. The method of claim 1, wherein the translations include at least one from a set of: a one-to-one translation, a one-to-many translation, a plurality of descriptions, and a synonym.

10. The method of claim 1, wherein the taxonomical hierarchy annotated with translation properties is rendered as one of: a document, a web page, and a selectable tree view through a client application.

11. The method of claim 1, wherein an availability and order of the translations within the taxonomic hierarchy is customized based on a region associated with a user.

12. A system for providing a hosted service with multilingual taxonomical hierarchy support, the system comprising:
a server configured to execute an application employing data organized in a taxonomical hierarchy, wherein the application is configured to:
create the hierarchy comprising nodes in a tree structure, wherein each node represents a term corresponding to one of a textual string and an audio file;
determine a list of translatable languages;
receive translated versions of the terms in one or more of the translatable languages;
associate each node with one or more labels, wherein each label corresponds to a translated version of a term in one of the translatable languages; and
designate a default language among the available languages in the hierarchy.

13. The system of claim 12, wherein the application is further configured to:
determine a working language used by a client application; and
enable rendering of the hierarchy through the client application using labels corresponding to the working language, wherein a default language label is used in place of a missing label in the working language.

14. The system of claim 13, wherein the default language is one of the translatable languages.

15. The system of claim 12, wherein each label is identified by a name in a corresponding translatable language.

16. The system of claim 12, wherein the translatable languages include at least one from a set of: a national language, a dialect, and a cultural language.

17. The system of claim 16, wherein the cultural language is associated with one of: a legal culture, a military culture, and a medical culture.

18. The system of claim 12, further comprising another server configured to provide translations of the terms.

19. A computer-readable storage medium with instructions stored thereon for providing multilingual taxonomical hierarchy support, the instructions comprising:
creating a hierarchy comprising nodes in a tree structure, wherein each node represents a term in a primary language;
determining a list of translatable languages;
receiving translated versions of the terms in one or more of the translatable languages;
associating each node with one or more labels as a node property, wherein each label corresponds to a translated version of a term in one of the translatable languages;
designating a default language among available languages in the hierarchy; and
enabling rendering of the hierarchy through a client application using labels corresponding to a working language of the client application, wherein a default language label is used in place of a missing label in the working language.

20. The computer-readable medium of claim 19, wherein a plurality or terms in a single translatable language are mapped to a term in the primary language through a plurality of labels.
